(19) United States
(12) Patent Application Publication
(10) Pub. No.: US 2026/0063970 A1
(43) Pub. Date: Mar. 5, 2026

(54) OPTICAL INSTRUMENT, IMAGING APPARATUS, AND METHOD OF MANUFACTURING OPTICAL INSTRUMENT

(71) Applicant: CANON KABUSHIKI KAISHA, Tokyo (JP)

(72) Inventor: MAKOTO HAYAKAWA, Tochigi (JP)

(21) Appl. No.: 19/308,946

(22) Filed: Aug. 25, 2025

(30) Foreign Application Priority Data
Sep. 5, 2024 (JP) 2024-152797

(51) Int. Cl. G03B 13/34

(52) U.S. Cl. CPC G03B 13/34

(57) ABSTRACT

An optical instrument includes a first part configured to hold an optical element; a second part configured to hold the first part; and a biasing member including a first engagement portion and a second engagement portion. One of the first part and the second part includes a third engagement portion engageable with the first engagement portion and a fourth engagement portion engageable with the second engagement portion. The other one of the first part and the second part includes a fifth engagement portion engageable with the second engagement portion. The second engagement portion is changeable between a first state in which the second engagement portion is engaged with the fourth engagement portion and a second state in which the second engagement portion is engaged with the fifth engagement portion. In the second state, the first part and the second part are mutually biased by the biasing member.

### BACKGROUND

### Technical Field

The present disclosure relates to an optical instrument such as an interchangeable lens, an imaging apparatus including the optical instrument, and a method of manufacturing the optical instrument.

### Description of the Related Art

Some interchangeable lens or the like include a mechanism that biases and holds, with a tension coil spring, a lens barrel or the like that holds a lens.

Japanese Patent Laid-Open No. 2023-50330 discusses an interchangeable lens that includes a mechanism that biases and holds, with a tension coil spring, a lens barrel or the like that holds a lens.

### SUMMARY

An aspect of the present disclosure provides an optical instrument that includes a first part configured to hold an optical element; a second part configured to hold the first part; and a biasing member that includes a first engagement portion and a second engagement portion. One of the first part and the second part includes a third engagement portion that is engageable with the first engagement portion and a fourth engagement portion that is engageable with the second engagement portion. The other one of the first part and the second part includes a fifth engagement portion that is engageable with the second engagement portion. The second engagement portion is changeable between a first state in which the second engagement portion is engaged with the fourth engagement portion and a second state in which the second engagement portion is engaged with the fifth engagement portion. In the second state, the first part and the second part are mutually biased by the biasing member.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating an overview configuration of a camera apparatus 1.

FIG. 2 is a perspective view illustrating a five-element barrel unit 412.

FIG. 3 is a plan view illustrating the five-element barrel unit 412.

FIG. 4 is a side view illustrating the five-element barrel unit 412.

FIG. 5 is a sectional view (a sectional view along A-A in FIG. 3) of the five-element barrel unit 412.

FIG. 6 is an enlarged view (a partial enlarged view of FIG. 3) of the five-element barrel unit 412.

FIG. 7 is a perspective view illustrating an assembly of a lens barrel 301 and a holding cylinder 302.

FIG. 8 is a side view illustrating an assembly of the lens barrel 301 and the holding cylinder 302.

### DESCRIPTION OF THE EMBODIMENTS

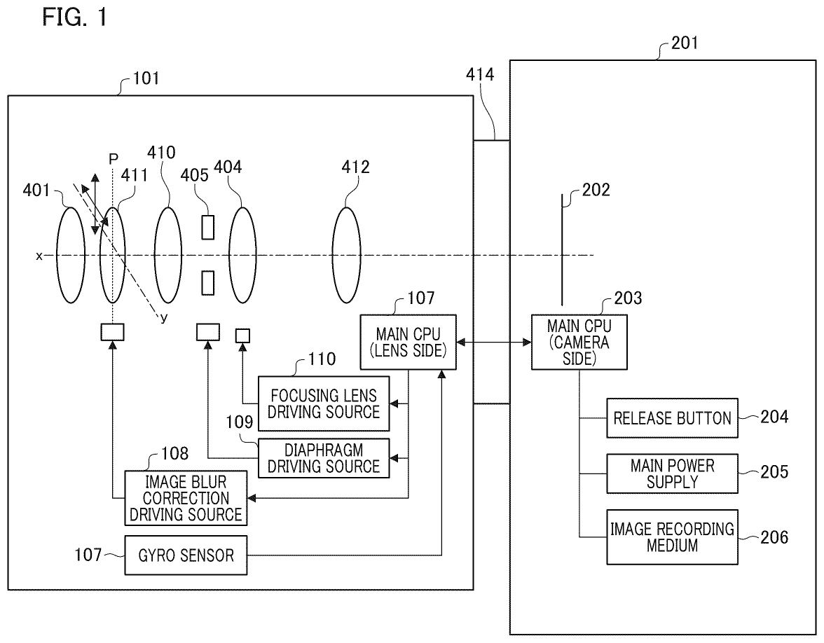

Hereinafter, an optical instrument and a camera apparatus according to an embodiment of the present disclosure will be described with reference to FIGS. 1 to 8. However, the present disclosure is not limited to the following embodiment. Note that the same members or elements will be denoted by the same reference signs in each drawing and description thereof will be omitted.

### Camera Apparatus 1

FIG. 1 is a schematic diagram illustrating an overview configuration of a camera apparatus 1.

The camera apparatus (imaging apparatus) 1 includes a lens device (optical device) 101 and a camera main body (imaging instrument) 201.

A direction along an optical axis will be referred to as an x direction (an x-axis in FIG. 1), a direction perpendicular to the x direction will be referred to as a y direction (a y-axis in FIG. 1, a yaw direction) and a direction perpendicular to each of the x direction and the y direction will be referred to as a p direction (pitch direction).

The lens device 101 includes a one-element barrel 401, a diaphragm unit 405, a focus barrel 404, a rear-element barrel 410, an image blur correction unit 411, and a five-element barrel unit 412. A lens group is held by each barrel.

The five-element barrel unit 412 is provided with cam followers 308, and the cam followers 308 are engaged with a cam groove of a cam ring and a straight advancing groove of a guide cylinder (both the cam ring and the guide cylinder are not illustrated).

The guide cylinder is engaged with the cam followers 308 and guides the holding cylinder 302 to advance straight. The cam ring is engaged with the cam followers 308 and causes the holding cylinder 302 to advance or treat in an optical axis direction. The optical axis is indicated by the x-axis in FIG. 1. The optical axis direction is a direction parallel to or along the x-axis, and may be referred to as an optical axis x.

In this manner, the five-element barrel unit 412 advances or retreats in the optical axis direction with a rotating operation of a zoom ring that moves in conjunction with the cam ring.

The lens device 101 also includes a gyro sensor 106, a lens-side main CPU 107, and the like. The gyro sensor 106 functions as a blur detection mechanism.

The lens-side main CPU 107 performs driving control and calculation of the entire lens. The lens-side main CPU 107 provides commands to a diaphragm driving source 109 and a focusing lens driving source 110 and drives the focus barrel 404 and the diaphragm unit 405.

When image blur correction control is performed, the lens-side main CPU 107 calculates the blur correction amount using a detection value of the gyro sensor 106 and sends a command to the image blur correction driving source 108. The blur correction is performed to cause the image blur correction unit 411 to be driven in the y direction and the p direction.

In this manner, the image blur correction unit 411 and the image blur correction driving source 108 function as an image blur correction mechanism.

Also, the lens-side main CPU 107 determines a holding state of the lens device 101 or the camera main body 201 from a detection value of the gyro sensor 106.

The one-element barrel 401 is fixed to the camera main body 201 via a mount 414. Also, an object is imaged by forming an image on an imaging element 202 held by the camera main body 201 through a lens 303 in a lens barrel 301.

The camera main body 201 includes a camera-side main CPU 203, an operation member release button 204, a main power source 205, an image recording medium 206, and the like.

The release button 204 is a two-step-pressing mechanism, the first step will be referred to as SW1, and the second step will be referred to as SW2.

With SW1, a command to prepare for a start of imaging such as recovery from an imaging standby state, a start of anti-shaking correction, a start of autofocusing, and a start of photometry is provided. With SW2, imaging is performed, and a command to record an image in the image recording medium 206 is also provided.

The camera main body 201 performs power supply from the camera-side main CPU 203 to the lens barrel and exchange of other imaging information with the lens-side main CPU 107 via a contact block (not illustrated) provided in the mount 414.

### Five-Element Barrel Unit 412

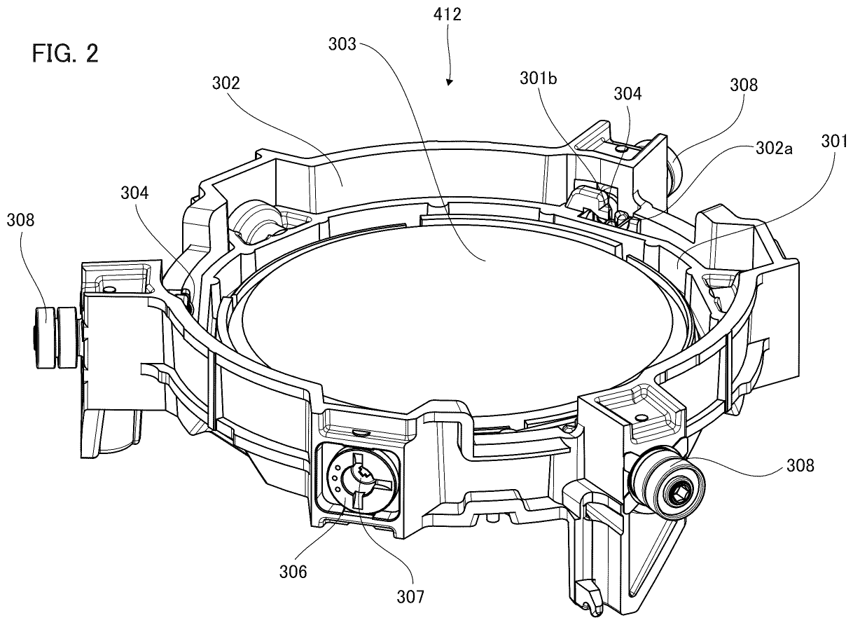

FIGS. 2 to 4 are diagrams illustrating the five-element barrel unit 412 (normal assembly position).

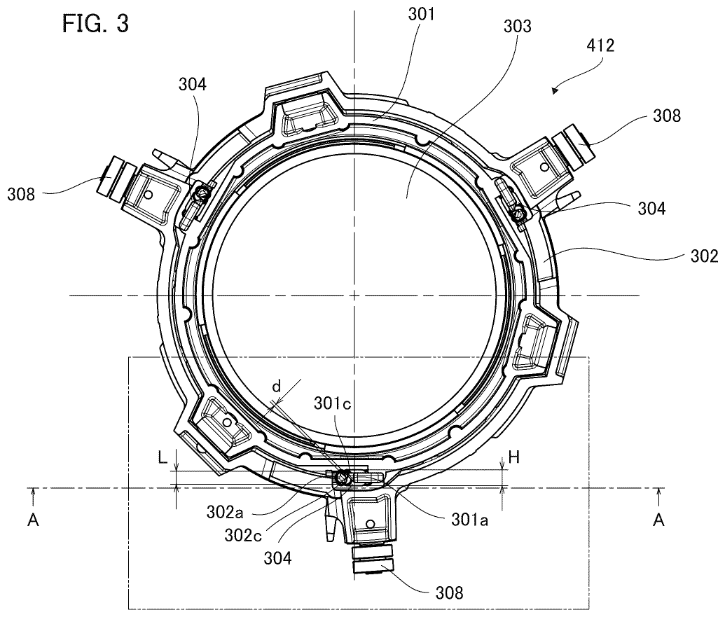

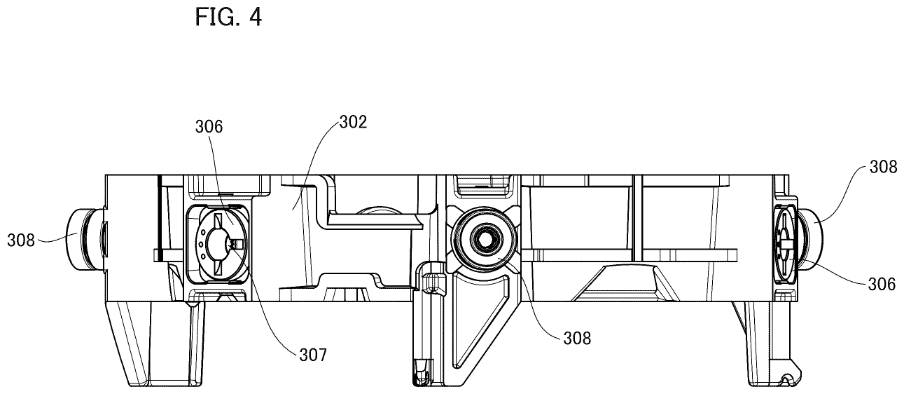

FIG. 2 is a perspective view, FIG. 3 is a plan view, and FIG. 4 is a side view.

The five-element barrel unit (optical instrument) 412 includes the lens barrel 301, the holding cylinder 302, the lens 303, a tension coil spring (biasing member) 304, eccentric rollers 306, screws 307, and the cam followers 308.

The lens barrel (first part) 301 holds the lens 303 (optical element). The lens barrel 301 and the holding cylinder (second part) 302 are coupled via three eccentric rollers 306.

The eccentric rollers 306 are friction-held by three screws 307 at the lens barrel 301 and are coupled thereto such that the eccentric rollers 306 are rotatable about an axis.

Each eccentric roller engagement portion of the holding cylinder 302 includes a vertical groove along the optical axis (x direction) and a horizontal groove in a circumferential direction perpendicular to the optical axis.

A cylindrical portion of each eccentric roller 306 corresponding to the horizontal groove is eccentric with respect to an attachment rotation axis of the eccentric roller. Therefore, if the eccentric roller 306 is rotated, then an eccentric roller fixing portion of the lens barrel 301 moves in the optical axis direction with respect to the holding cylinder 302. The position of the lens barrel 301 with respect to the holding cylinder 302 changes.

Therefore, it is possible to adjust falling-down of the lens barrel 301 by adjusting the rotational positions of the plurality of eccentric rollers 306.

Each cam follower 308 includes two bearing portions. The cam follower 308 includes a shaft screw pressure-fit holding a bearing, and is fixed to the holding cylinder 302 by sandwiching the holding cylinder 302 with a nut, which is not illustrated.

The three cam followers 308 are fixed to the holding cylinder 302. The two bearings of each cam follower 308 are engaged with the cam groove of the cam ring and the straight advancing groove of the guide cylinder, respectively.

In this manner, the five-element barrel unit 412 advances and retreats in the optical direction with the rotating operation of the zoom ring that moves in conjunction with the cam ring.

### One-Sided Biasing Mechanism

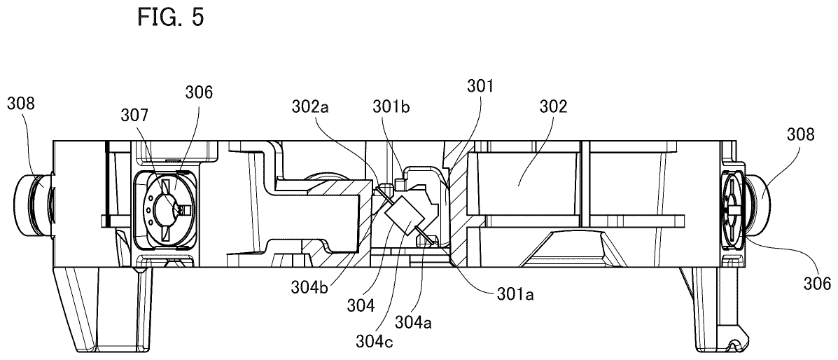

FIG. 5 is a sectional view (a sectional view along A-A in FIG. 3) of the five-element barrel unit 412.

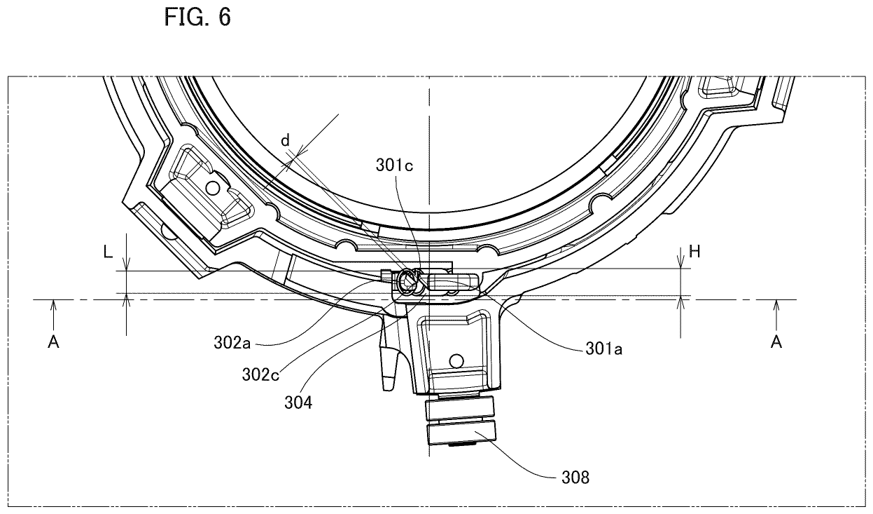

FIG. 6 is an enlarged view (a partial enlarged view of FIG. 3) of the five-element barrel unit 412.

The tension coil spring 304 is configured of a first hook (first engagement portion) 304a, a second hook (second engagement portion) 304b, and a coil main body 304c. The first hook 304a, the second hook 304b, or both may be an annular portion.

The tension coil spring 304 is stretched from the holding cylinder 302 of the lens barrel 301 and tension-biases the lens barrel 301 and the holding cylinder 302.

The tension coil spring 304 is assembled with the lens barrel 301 in advance.

The lens barrel 301 is provided with a first hooking portion (third engagement portion) 301a and a third hooking portion (fourth engagement portion) 301b. The first hook 304a is hooked on the first hooking portion 301a, and the second hook 304b is hooked on (locked at) the third hooking portion 301b (a first state). The tension coil spring 304 is temporarily held by the lens barrel 301 in an extended state. The first hooking portion 301a, the third hooking portion 301b, or both may be a projecting portion.

Note that the first hook 304a may be a hooking portion, while the first hooking portion may be a hook. In other words, the first hook 304a may be a hooking portion (receiving portion) or may be a hook. In the present application, the hooking portion (received portion) and the hook will be referred to as engagement portions. Similarly, the second hook 304 may be a hooking portion, while the third hooking portion 301b may be a hook.

After the lens barrel 301 and the holding cylinder 302 are coupled, the tension coil spring 304 is stretched from the holding cylinder 302 of the lens barrel 301.

The holding cylinder 302 is provided with the second hooking portion (fifth engagement portion) 302a. The second hook 304b of the tension coil spring 304 is hooked on (locked at) the second hooking portion 302a (a second state). In other words, the second hook 304b is replaced from the third hooking portion 301b to the second hooking portion 302a. The second hooking portion 302a may be a projecting portion.

The second hook 304b is pulled by using a tool such as a pair of tweezers to extend the coil main body 304c, and the second hook 304b is detached from the third hooking portion 301b. Then, the second hook 304b is moved and is hooked on the second hooking portion 302a.

An assembly of the lens barrel 301, the holding cylinder 302, and the tension coil spring 304 will be described in detail.

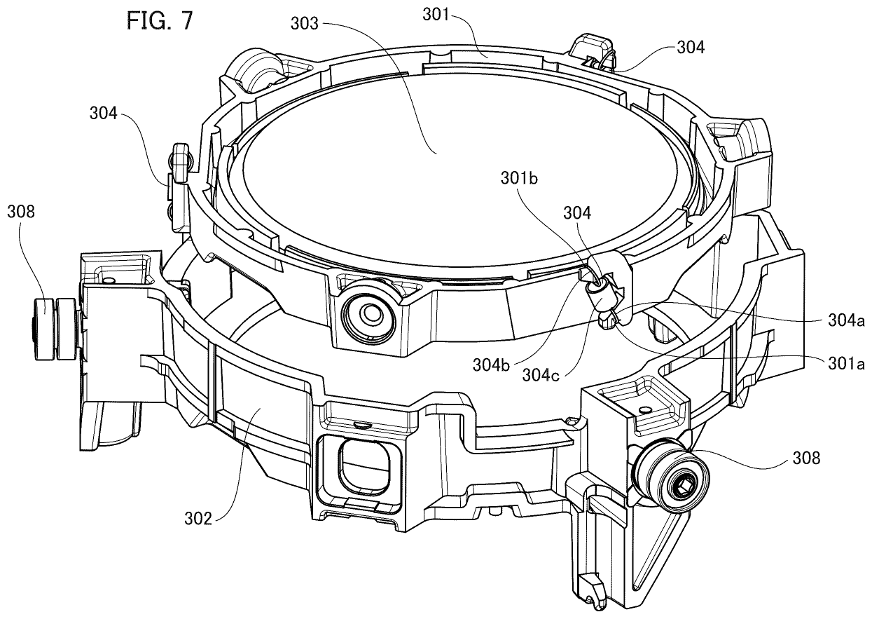

FIG. 7 is a perspective view illustrating an assembly of the lens barrel 301 and the holding cylinder 302.

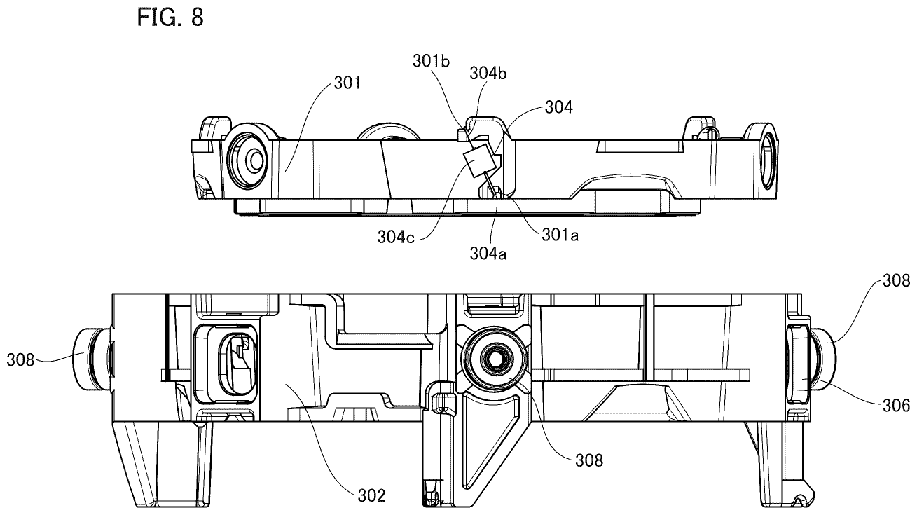

FIG. 8 is a side view illustrating an assembly of the lens barrel 301 and the holding cylinder 302.

Initially, the lens barrel 301 is caused to temporarily hold the tension coil spring 304. In other words, the first hook 304a of the tension coil spring 304 is hooked on the first hooking portion 301a, and the second hook 304b is hooked on the third hooking portion 301b.

Next, the lens barrel 301 including the tension coil spring 304 assembled therewith is fitted to the holding cylinder 302 (dropped at an assembly position).

Then, the eccentric rollers 306 are fixed to the lens barrel 301 at three locations with the screws 307 through opening portions in the holding cylinder 302. In this manner, the lens barrel 301 is held at a normal assembly position of the holding cylinder 302.

At the normal assembly position, the third hooking portion 301b of the lens barrel 301 and the second hooking portion 302a of the holding cylinder 302 are adjacent to each other. A clearance d is formed in a direction perpendicular to the optical axis (x direction) between the third hooking portion 301b and the second hooking portion 302a.

The third hooking portion 301b is provided with a third hook introducing end (first engagement portion introducing end) 301c that guides introduction of the second hook 304b. The second hooking portion 302a of the holding cylinder 302 is provided with a second hook introducing end (second engagement portion introducing end) 302c that guides introduction of the second hook 304b. The third hook introducing end 301c and the second hook introducing end 302c are disposed to be adjacent to each other with the clearance d left therebetween.

As illustrated in FIG. 3, the third hooking portion 301b and the second hook 304b are exposed in the x direction. The x direction is a direction in which approaching (accessing) to the second hook 304b is possible.

Therefore, it is possible to access (approach) the second hook 304b with a pair of tweezers or the like in the x direction.

The second hook 304b is transferred (replaced) from the third hooking portion 301b of the lens barrel 301 to the second hooking portion 302a of the holding cylinder 302 using a pair of tweezers or the like.

The second hook 304b is detached from the third hooking portion 301b via the third hook introducing end 301c. The second hook 304b crosses the clearance d and moves to the second hook introducing end 302c. Then, the second hook 304b is transferred to the second hooking potion 302a via the second hook introducing end 302c.

In this manner, the tension coil spring 304 is assembled at a normal assembly position. In other words, the first hook 304a of the tension coil spring 304 is hooked on the first hooking portion 301a, and the second hook 304b is hooked on the second hooking portion 302a.

If the tension coil spring 304 is assembled at the normal assembly position, the lens barrel 301 is biased against the holding cylinder 302 and is bias-held by abutting portions of the eccentric rollers 306 with no backlash.

As illustrated in FIG. 3, the clearance between the lens barrel 301 and the holding cylinder 302 is smaller than an outer diameter H of the coil main body 304c. Therefore, the tension coil spring 304 cannot fall off from between the lens barrel 301 and the holding cylinder 302. In addition, it is also not possible to assemble the tension coil spring 304 with the second hooking portion 302a of the holding cylinder 302.

In this manner, since the clearance between the lens barrel 301 and the holding cylinder 302 is smaller than the outer diameter H of the coil main body 304c, it is possible to reduce the size of the device.

It is not necessary to visually recognize the first hooking portion 301a. It is possible to achieve the assembling (the replacement of the second hook 304b) without any problems even if the first hooking portion 301a is disposed behind (in a partially or entirely hidden manner) the second hooking portion 302a.

In this manner, the limitation of disposition of the tension coil spring 304, the first hooking portion 301a, and the second hooking portion 302a is reduced, and efficient disposition can be achieved.

As illustrated in FIG. 3, the second hooking portion 302a of the lens barrel 301 is disposed behind the lens barrel 301 (hidden and cannot be visually recognized). The first hook 304a of the tension coil spring 304 is hooked on the second hooking portion 302a in an initial stage of the assembling. In other words, the first hook 304a of the tension coil spring 304 is disposed at a position from which it cannot be detached.

As described above, the lens barrel 301 moves in the optical axis direction due to rotation of the eccentric rollers 306.

If the clearance d between the third hooking portion 301 and the second hooking portion 302a is set in the direction perpendicular to the optical axis, then the clearance d less varies even if lens position adjustment is performed with the eccentric rollers 306. In other words, the clearance d is kept constant.

Therefore, it is not necessary to unnecessarily increase the clearance d in consideration of the amount of variations at the time of the adjustment. Therefore, it is possible to reduce the clearance d and to prevent the second hook 304b of the tension coil spring 304 from falling off at the time of replacement.

If the diameter of the second hook 304b of the tension coil spring 304 is defined as L, according to Equation (1):

d<L (1).

It is possible to prevent the second hook 304b of the tension coil spring 304 from falling off at the time of the replacement by setting the size of the clearance d to be smaller than the diameter L of the second hook 304b in this manner.

Both the third hook introducing end 301c of the third hooking portion 301b and the second hook introducing end 302c of the second hooking portion 302a are formed to have shapes with sharp tips.

In this manner, it is possible to cause the third hook introducing end 301c and the second hook introducing end 302c to overlap one another as much as possible and to prevent the second hook 304c from falling off at the time of the replacement.

As illustrated in FIGS. 4 and 5, the tension coil spring 304 is disposed behind the holding cylinder 302, that is, on the optical axis side (hidden and cannot be visually recognized) when seen from radially outer side perpendicular to the optical axis. Since the tension coil spring 304 is assembled in advance, there is no need to provide a notch in a side wall of the holding cylinder 302. Therefore, it is possible to enhance the strength of the holding cylinder 302 than before.

Also, since there is no need to increase the outer diameter to secure the strength, it is possible to reduce the outer diameter of the holding cylinder 302, and as a result, it is possible to reduce the entire size of the optical instrument.

Moreover, the tension coil spring 304 is disposed behind (hidden and cannot be visually recognized) the cam follower 308, that is, on the optical axis side when seen from radially outer side perpendicular to the optical axis as illustrated in FIGS. 4 and 5.

Since there is no need to provide a notch in an outer wall of the holding cylinder 302, it is possible to dispose the tension coil spring 304 inside the cam followers 308. In this manner, it is possible to dispose necessary elements with satisfactory disposition efficiency and to thereby reduce the entire size of the optical instrument.

As described above, according to the present disclosure, it is possible to minimize the assembling space of the tension coil spring 304 and to achieve size reduction and weight reduction of the entire optical instrument.

The first part is not limited to the lens barrel 301, and the second part is not limited to the holding cylinder 302. The first part may be the holding cylinder 302, and the second part may be the lens barrel 301. In other words, one of the first part and the second part is a lens barrel that holds a lens, and the other one is a holding cylinder that holds the lens barrel.

Although the one-sided biasing mechanism that places the lens barrel 301 and the holding cylinder 302 on one side using the tension coil spring 304 has been described in the embodiment, the present disclosure can also be used for other one-sided biasing mechanisms. For example, the present disclosure may also be applied to a mechanism that biases a movable lens with a tension coil spring to achieve anti-shaking.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-152797, filed on Sep. 5, 2024, the entirety of which is incorporated herein by reference.

What is claimed is:

1. An optical instrument comprising:
a first part configured to hold an optical element;
a second part configured to hold the first part; and
a biasing member that includes a first engagement portion and a second engagement portion, wherein:
one of the first part and the second part includes a third engagement portion that is engageable with the first engagement portion and a fourth engagement portion that is engageable with the second engagement portion,
the other one of the first part and the second part includes a fifth engagement portion that is engageable with the second engagement portion,
the second engagement portion is changeable between a first state in which the second engagement portion is engaged with the fourth engagement portion and a second state in which the second engagement portion is engaged with the fifth engagement portion, and
in the second state, the first part and the second part are mutually biased by the biasing member.

2. The optical instrument according to claim 1, wherein in both the first state and the second state, the first engagement portion is engaged with the third engagement portion.

3. The optical instrument according to claim 1, wherein:
the first engagement portion and the second engagement portion are annular portions, and
the third engagement portion, the fourth engagement portion, and the fifth engagement portion are projecting portions.

4. The optical instrument according to claim 1, further comprising:
eccentric rollers disposed between the first part and the second part, wherein:
the biasing member is configured to tension-bias the second part and the first part, and
a position of the first part changes with respect to the second part due to rotation of the eccentric rollers.

5. The optical instrument according to claim 1, further comprising:
a second engagement portion introducing end of the fifth engagement portion; and
a first engagement portion introducing end of the fourth engagement portion,
wherein the first engagement portion and the second engagement portion are disposed adjacent to each other with a clearance therebetween.

6. The optical instrument according to claim 5, wherein the clearance is less than a diameter of the second engagement portion.

7. The optical instrument according to claim 5, wherein, the clearance does not change when a position of the first part changes with respect to the second part.

8. The optical instrument according to claim 1, wherein the biasing member is disposed on a side of an optical axis of the second part, viewed from an outer side perpendicular to the optical axis, in both the first state and the second state.

9. The optical instrument according to claim 1, further comprising:
at least one cam follower disposed at the second part;
a guide cylinder configured to engage the at least one cam follower and guide the second part; and
a cam ring configured to engage the at least one cam follower, and to advance and retreat the second part in an optical axis direction,
wherein the biasing member is disposed on a side of an optical axis of the at least one cam follower, viewed from an outer side perpendicular to the optical axis.

10. An optical instrument comprising:
a first part configured to hold an optical element;
a second part configured to hold the first part; and
a biasing member that includes a first engagement portion and a second engagement portion, wherein:
one of the first part and the second part includes a third engagement portion that is engageable with the first engagement portion and a fourth engagement portion that is engageable with the second engagement portion,
the other one of the first part and the second part includes a fifth engagement portion that is engageable with the second engagement portion, and
a first clearance between the first part and the second part is narrower than the second engagement portion in both a first state in which the second engagement portion is engaged with the fourth engagement portion and a second state in which the second engagement portion is engaged with the fifth engagement portion.

11. The optical instrument according to claim 10, wherein in both the first state and the second state, the first engagement portion is engaged with the third engagement portion.

12. The optical instrument according to claim 10, wherein:
the first engagement portion and the second engagement portion are annular portions, and
the third engagement portion, the fourth engagement portion, and the fifth engagement portions are projecting portions.

13. The optical instrument according to claim 10, further comprising:
eccentric rollers disposed between the first part and the second part, wherein:
the biasing member is configured to tension-bias the second part and the first part, and
a position of the first part changes with respect to the second part due to rotation of the eccentric rollers.

14. The optical instrument according to claim 10, further comprising:
a second engagement portion introducing end of the fifth engagement portion, and
a first engagement portion introducing end of the fourth engagement portion,
wherein the first engagement portion and the second engagement portion are disposed adjacent to each other with a second clearance therebetween.

15. The optical instrument according to claim 14, wherein the second clearance is less than a diameter of the second engagement portion.

16. The optical instrument according to claim 10, wherein the biasing member is disposed behind the second part, viewed in a direction perpendicular to an optical axis, in both the first state and the second state.

17. The optical instrument according to claim 10, further comprising:
at least one cam follower disposed at the second part;
a guide cylinder configured to engage the at least one cam follower and guide the second part; and
a cam ring configured to engage the at least one cam follower, and to advance and retreat the second part in an optical axis direction,
wherein the biasing member is disposed behind the at least one cam follower, viewed from a radial direction perpendicular to an optical axis.

18. An imaging apparatus comprising:
the optical instrument according to claim 1; and
an imaging element.

19. An imaging apparatus comprising:
an imaging element,
wherein the optical instrument according to claim 1 is attachable to and detachable from the imaging apparatus.

20. A method of manufacturing an optical instrument including a first part configured to hold an optical element, a second part, and a biasing member that includes a first engagement portion and a second engagement portion, the method comprising:
causing the first engagement portion engage a third engagement portion provided in one of the first part and the second part;
causing the second engagement portion engage a fourth engagement portion;
causing the second part to hold the first part;
disengaging the second engagement portion from the fourth engagement portion; and
causing the second engagement portion to engage a fifth engagement portion provided in the other one of the first part and the second part.
